(19) United States
(12) Patent Application Publication
(10) Pub. No.: US 2019/0291840 A1
(43) Pub. Date: Sep. 26, 2019

(54) Boat-Mounted Wind Power Assembly

(71) Applicant: Shirley Street, Colonie, NY (US)

(72) Inventor: Shirley Street, Colonie, NY (US)

(21) Appl. No.: 15/925,993

(22) Filed: Mar. 20, 2018

(51) Int. Cl. B63J 3/04; H02K 7/18; H02K 11/04; H02K 11/00; H02K 7/116; H02J 7/14

(52) U.S. Cl. CPC B63J 3/04; H02K 7/183; H02K 11/046; B63J 2003/002; H02K 7/116; H02J 7/1415; B63J 2003/046; H02K 11/0094

(57) ABSTRACT

A boat-mounted wind power assembly for powering devices of a boat includes a first shaft that is rotatably coupled to and extends vertically from a boat. A plurality of blades is coupled to and extends from the first shaft. A generator is operationally coupled to the first shaft. A rectifier is operationally coupled the generator. A battery, which is rechargeable, is operationally coupled to the rectifier. The battery is selectively couplable to devices of the boat. The blades are configured to convert kinetic energy of wind into rotation of the first shaft. The generator is positioned to convert rotation of the first shaft into unstable alternating current. The rectifier is positioned to convert the unstable alternating current from the generator to direct current so that the battery is charged by the generator. The battery is configured to supply direct current to power the devices of the boat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to wind power assemblies and more particularly pertains to a new wind power assembly for powering devices of a boat.

### BRIEF SUMMARY OF THE INVENTION

An embodiment of the disclosure meets the needs presented above by generally comprising a first shaft that is rotatably coupled to and extends vertically from a boat. A plurality of blades is coupled to and extends from the first shaft. A generator is operationally coupled to the first shaft. A rectifier is operationally coupled the generator. A battery, which is rechargeable, is operationally coupled to the rectifier. The battery is selectively couplable to devices of the boat. The blades are configured to convert kinetic energy of wind into rotation of the first shaft. The generator is positioned to convert rotation of the first shaft into unstable alternating current. The rectifier is positioned to convert the unstable alternating current from the generator to direct current so that the battery is charged by the generator. The battery is configured to supply direct current to power the devices of the boat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a boat-mounted wind power assembly according to an embodiment of the disclosure.

FIG. 2 is a side view of an embodiment of the disclosure.

FIG. 3 is a top view of an embodiment of the disclosure.

FIG. 4 is a block diagram of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

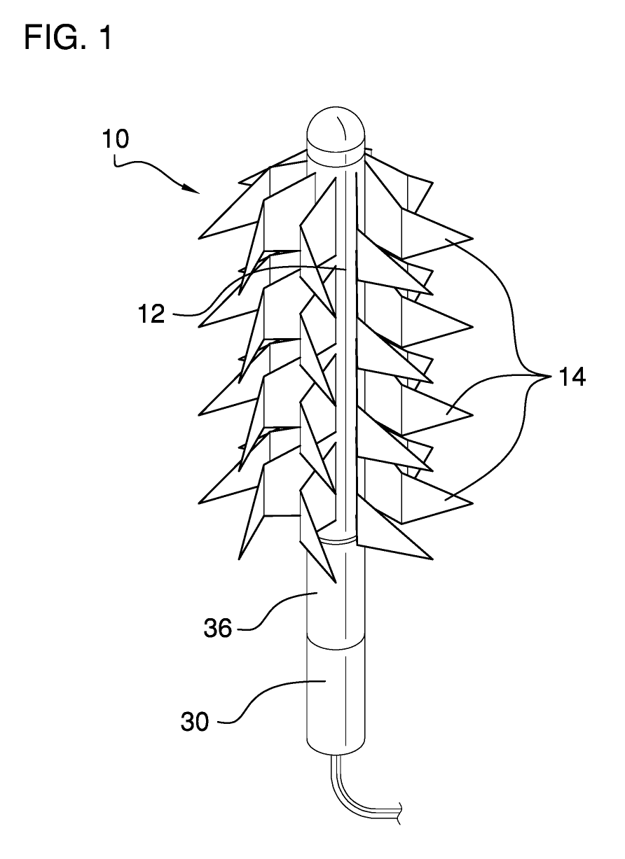

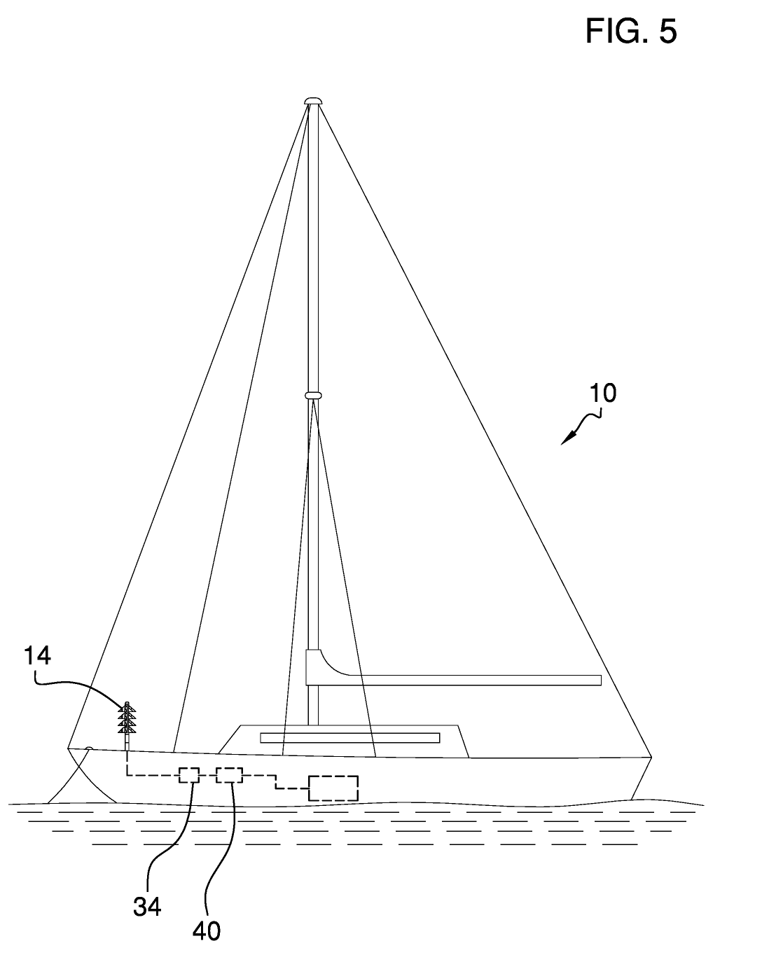

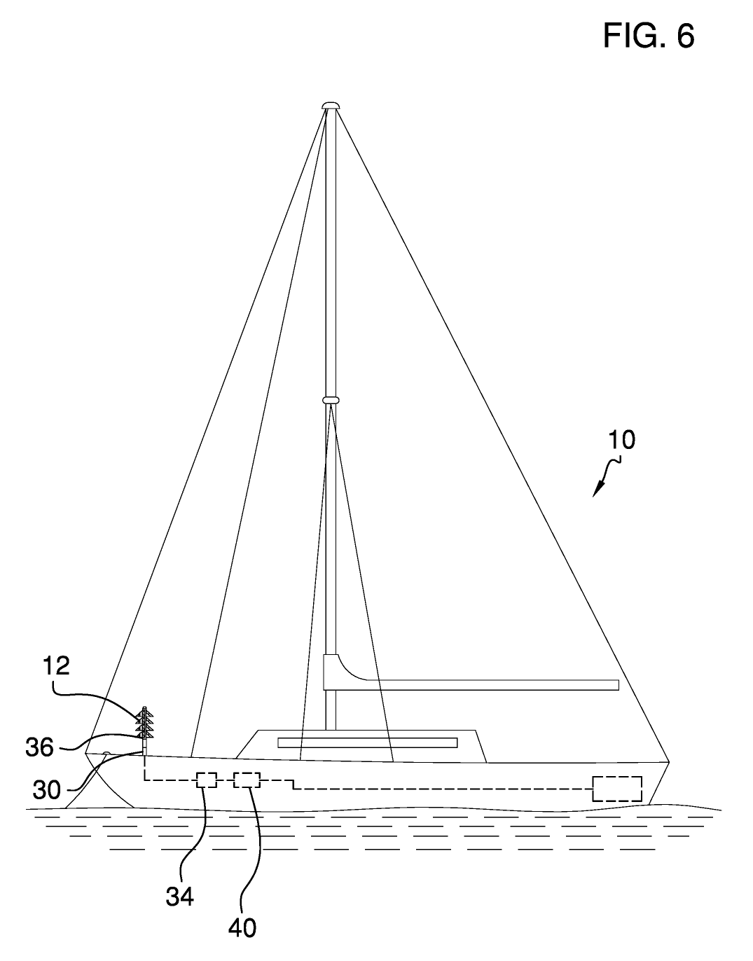

With reference now to the drawings, and in particular to FIGS. 1 through 6 thereof, a new wind power assembly embodying the principles and concepts of an embodiment of the disclosure and generally designated by the reference numeral 10 will be described.

As best illustrated in FIGS. 1 through 6, the boat-mounted wind power assembly 10 generally comprises a first shaft 12 that is rotatably coupled to and extends vertically from a boat. A plurality of blades 14 is coupled to and extends from the first shaft 12. The blades 14 are configured to convert kinetic energy of wind into rotation of the first shaft 12. Each blade 14 is substantially triangularly shaped, defining a base 16 and an apex 18 of the blade 14. The base 16 is coupled to the first shaft 12.

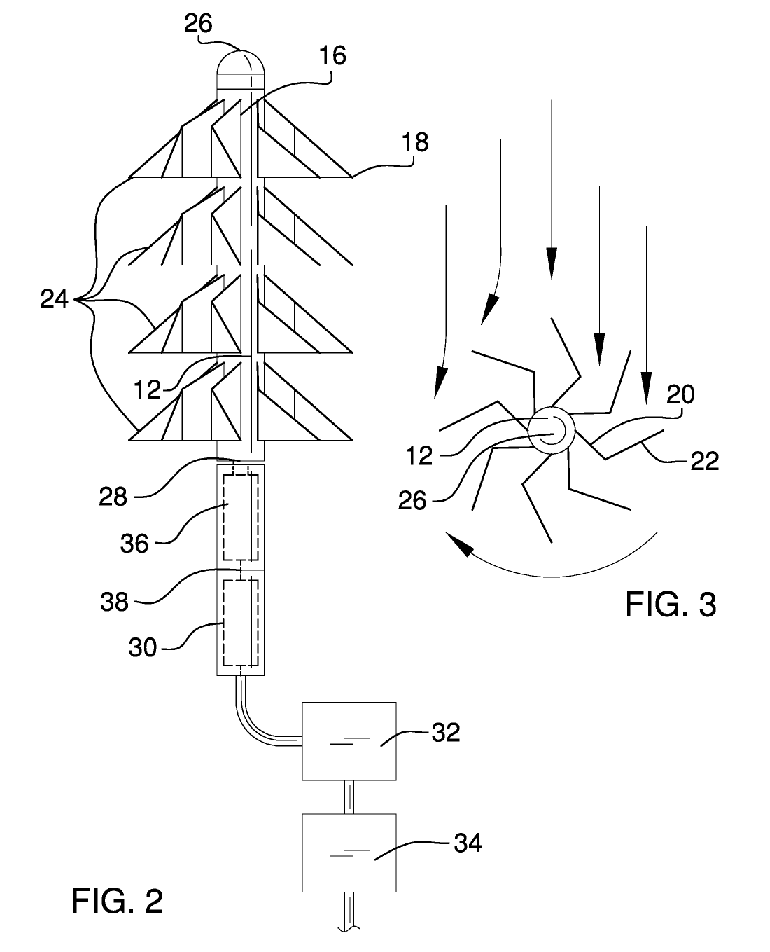

Each blade 14 comprises a first section 20 and a second section 22. The first section 20 extends transversely from the first shaft 12. The second section 22 extends angulary from the first section 20, as shown in FIG. 3. The plurality of blades 14 is positioned in a plurality of sets 24, as shown in FIG. 2. The plurality of sets 24 extends between a top end 26 and a bottom end 28 of the first shaft 12. The plurality of sets 24 comprises four sets 24. Each of the plurality of sets 24 comprises eight blades 14.

A generator 30 is operationally coupled to the first shaft 12. The generator 30 is positioned to convert rotation of the first shaft 12 into unstable alternating current. A rectifier 32 is operationally coupled the generator 30. The rectifier 32 is positioned to convert the unstable alternating current from the generator 30 to direct current.

A battery 34, which is rechargeable, is selectively couplable to devices of the boat. The battery 34 is operationally coupled to the rectifier 32 so that the battery 34 is charged by the generator 30. The battery 34 is configured to supply direct current to power the devices of the boat, such a motor and lights that operate on direct current.

A gearbox 36 is operationally coupled to and is positioned between the generator 30 the bottom end 28 of the first shaft 12. A second shaft 38 is operationally coupled to and extends from the gearbox 36. The second shaft 38 is operationally coupled to the generator 30. The gearbox 36 is positioned to selectively provide speed conversion and torque conversion between the first shaft 12 and the second shaft 38.

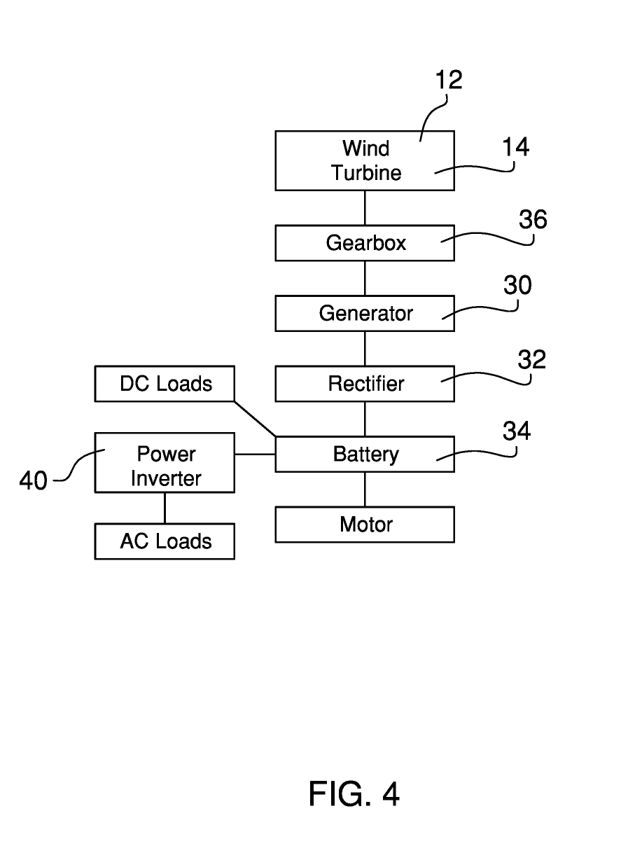

A power inverter 40 is operationally coupled to the battery 34, as shown in FIG. 4. The power inverter 40 is positioned to convert direct current from the battery 34 to alternating current to power the devices of the boat, such a motor and lights that operate on alternating current.

In use, the blades 14 are configured to convert kinetic energy of wind into rotation of the first shaft 12. The gearbox 36 is positioned to selectively provide speed conversion and torque conversion between the first shaft 12 and the second shaft 38. The generator 30 is positioned to convert rotation of the second shaft 38 into unstable alternating current. The rectifier 32 is positioned to convert the unstable alternating current from the generator 30 to direct current so that the battery 34 is charged by the generator 30. The battery 34 is configured to supply direct current to power the devices of the boat, such the motor and the lights that operate on direct current. The power inverter 40 is positioned to convert direct current from the battery 34 to alternating current to power the devices of the boat, such the motor and the lights that operate on alternating current

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A boat-mounted wind power assembly comprising:
a first shaft rotatably coupled to and extending vertically from a boat;
a plurality of blades coupled to and extending from said first shaft, each said blade comprising a first section and a second section, said first section extending from said first shaft and said second section extending from said first section, said first section and said second section each being planar and defining an obtuse angle therebetween, said first section defining an acute angle with said first shaft, said acute angle and said obtuse angle being on respective opposite sides of said first section;
a generator operationally coupled to said first shaft;
a rectifier operationally coupled said generator;
a battery, said battery being rechargeable, said battery being operationally coupled to said rectifier, said battery being selectively couplable to devices of the boat; and
wherein said blades are configured for converting kinetic energy of wind into rotation of said first shaft, wherein said generator is positioned for converting rotation of said first shaft into unstable alternating current, wherein said rectifier is positioned for converting the unstable alternating current from said generator to direct current such that said battery is charged by said generator, wherein said battery is configured for supplying direct current for powering the devices of the boat.

2. The assembly of claim 1, further including each said blade being substantially triangularly shaped defining a base and an apex of said blade, said base being coupled to said first shaft.

3. (canceled)

4. The assembly of claim 1, further including said plurality of blades being positioned in a plurality of sets, said plurality of sets extending between a top end and a bottom end of said first shaft.

5. The assembly of claim 4, further including said plurality of sets comprising four said sets.

6. The assembly of claim 4, further including each of said plurality of sets comprising eight said blades.

7. The assembly of claim 1, further comprising:
a gearbox operationally coupled to and positioned between said generator said bottom end of said first shaft;
a second shaft operationally coupled to and extending from said gearbox, said second shaft being operationally coupled to said generator; and
wherein said gearbox is positioned for selectively providing speed conversion and torque conversion between said first shaft and said second shaft;

8. The assembly of claim 1, further including a power inverter operationally coupled to said battery wherein said power inverter is positioned for converting direct current from said battery to alternating current for powering the devices of the boat.

9. A boat-mounted wind power assembly comprising:
a first shaft rotatably coupled to and extending vertically from a boat;
a plurality of blades coupled to and extending from said first shaft wherein said blades are configured for converting kinetic energy of wind into rotation of said first shaft, each said blade being substantially triangularly shaped defining a base and an apex of said blade, said base being coupled to said first shaft, each said blade comprising a first section and a second section, said first section extending from said first shaft, said second section extending from said first section, said first section and said second section each being planar and defining an obtuse angle therebetween, said first section defining an acute angle with said first shaft, said acute angle and said obtuse angle being on respective opposite sides of said first section, said plurality of blades being positioned in a plurality of sets, said plurality of sets extending between a top end and a bottom end of said first shaft, said plurality of sets comprising four said sets, each of said plurality of sets comprising eight said blades;
a generator operationally coupled to said first shaft wherein said generator is positioned for converting rotation of said first shaft into unstable alternating current;
a gearbox operationally coupled to and positioned between said generator said bottom end of said first shaft;
a second shaft operationally coupled to and extending from said gearbox, said second shaft being operationally coupled to said generator wherein said gearbox is positioned for selectively providing speed conversion and torque conversion between said first shaft and said second shaft;
a rectifier operationally coupled said generator; wherein said rectifier is positioned for converting the unstable alternating current from said generator to direct current;
a battery, said battery being rechargeable, said battery being selectively couplable to devices of the boat, said battery being operationally coupled to said rectifier such that said battery is charged by said generator, wherein said battery is configured for supplying direct current for powering the devices of the boat; and
a power inverter operationally coupled to said battery wherein said power inverter is positioned for converting direct current from said battery to alternating current for powering the devices of the boat.
